(19) United States
(12) Patent Application Publication
(10) Pub. No.: US 2008/0162998 A1
(43) Pub. Date: Jul. 3, 2008

(54) AUTOMATIC RECONFIGURATION OF AN I/O BUS TO CORRECT FOR AN ERROR BIT

(75) Inventors: Robert B. Likovich, Raleigh, NC (US); Robert J. Reese, Austin, TX (US); Joseph D. Mendenhall, Cary, NC (US); Kenneth J. Barker, Holly Springs, NC (US)

Correspondence Address: IBM CORP (WSM);C/O WINSTEAD SECHREST & MINICK P.C., PO BOX 50784, DALLAS, TX, 75201, US

(73) Assignee: International Business Machines Corporation, Armonk, NY (US)

(21) Appl. No.: 12/048,284

(22) Filed: Mar. 14, 2008

Related U.S. Application Data
(63) Continuation of application No. 11/055,807, filed on Feb. 11, 2005.

(51) Int. Cl. G06F 11/00

(52) U.S. Cl. 714/28; 714/E11.001

(57) ABSTRACT

A test pattern is loaded into a driver data shift register and sent from a driver chip to a receive chip over an M bit bus (0 to M−1). The test pattern is also generated at the receiver chip and used to compare to the actual received data. Failed compares are stored as logic ones in a bit error register (BER). A counter determines the number of failures by counting logic ones from the BER. The contents of a error position counter are latched in a error position latch and used to load a logic one (at the error bit position) into daisy chained self-heal control registers (SCR) in the receiver chip and the driver chip. The SCR sets a logic one into all bit positions after the error bit isolating the failed bit path and adding a spare bit path which is in bit position M.

### TECHNICAL FIELD

The present invention relates in general to chip and board level line drivers and receivers, and in particular, to error correction circuitry redirecting data from a failed data path to a spare data path.

### BACKGROUND INFORMATION

Digital computer systems have a history of continually increasing the speed of the processors used in the system. As computer systems have migrated towards multiprocessor systems, sharing information between processors and memory systems has also generated a requirement for increased speed for the off-chip communication networks. Designers usually have more control over on-chip communication paths than for off-chip communication paths. Off-chip communication paths are longer, have higher noise, impedance mismatches, and have more discontinuities than on-chip communication paths. Since off-chip communication paths are of lower impedance, they require more current and thus more power to drive.

When using inter-chip high-speed signaling, noise and coupling between signal lines (crosstalk) affects signal quality. One way to alleviate the detrimental effects of noise and coupling is through the use of differential signaling. Differential signaling comprises sending a signal and its complement to a differential receiver. In this manner, noise and coupling affect both the signal and the complement equally. The differential receiver only senses the difference between the signal and its complement as the noise and coupling represent common mode signals. Therefore, differential signaling is resistant to the effects that noise and crosstalk have on signal quality. On the negative side, differential signaling increases pin count by a factor of two for each data line. The next best thing to differential signaling is pseudo-differential signaling. Pseudo-differential signaling comprises comparing a data signal to a reference voltage using a differential receiver or comparator.

When high speed data is transmitted between chips, the signal lines are characterized by their transmission line parameters. High speed signals are subject to reflections if the transmission lines are not terminated in an impedance that matches the transmission line characteristic impedance. Reflections may propagate back and forth between driver and receiver and reduce the margins when detecting signals at the receiver. Some form of termination is therefore usually required for all high-speed signals to control overshoot, undershoot, and increase signal quality. Typically, a Thevenin's resistance (equivalent resistance of the Thevenin's network equals characteristic impedance of transmission line) is used to terminate data lines allowing the use of higher valued resistors. Additionally, the Thevenin's network is used to establish a bias voltage between the power supply rails. In this configuration, the data signals will then swing around this Thevenin's equivalent bias voltage. When this method is used to terminate data signal lines, a reference voltage is necessary to bias a differential receiver that operates as a pseudo-differential receiver to detect data signals in the presence of noise and crosstalk.

The logic levels of driver side signals are determined by the positive and ground voltage potentials of the driver power supply. If the driver power supply has voltage variations that are unregulated, then the logic one and logic zero levels of the driver side signals will undergo similar variations. If the receiver is substantially remote from the driver such that its power supply voltage may undergo different variations from the driver side power supply, then additional variations will be added to any signal received in a receiver side terminator (e.g., Thevenin's network). These power supply variations will reduce noise margins if the reference has variations different from those on the received signals caused by the driver and receiver side power supply variations.

The popular technique of source-synchronous clocking is often used for high speed interface systems. With this technique, the transmitting device sends a clock with the data. The advantage of this approach is that the maximum performance is no longer computed from the clock-to-output delay, propagation delay, and set up times of the devices and the circuit board. Instead, the maximum performance is related to the maximum edge rate of the driver and the skew between the data signals and the clock signals. Using this technique, data may be transferred at a multi-gigahertz rates even though the propagation delay from transmitter to receiver may exceed one nanosecond. If standard double-data rate (DDR) driving is utilized, data is launched on both the rising and falling edges of the clock. In this case, duty cycle symmetry of the clock as detected at the receiver becomes important since each edge of the clock is also used to recover the data at the receiving end of the data path. If the clock is asymmetrical, then it will affect the eye pattern of the data signals that the clock is used to detect.

As the frequency of the data and clock signals increase, the amount of skew between the data signals and the clock signal in a clock group becomes important. The delay of the transmission path may be several clock cycles. To accurately detect data and to align all of the data signals before sending to core logic in a receiving chip, the data signals are delayed relative to the clock until an optimum sampling time is achieved. This is ideally in the middle of the eye window of the data signals. Since the data signals are sampled with a clock, the amount of delay in the delay line in the data paths is relative to the clock signal. If environmental factors cause the delay of the delay line to vary, then accurately sampling the clock may be comprised or may cause errors.

In modern processor systems many wide interconnect buses are used to connect between chips, modules, cards, and boards. As the number of interconnects increase, it grows increasingly important to be able to quickly and easily test the continuity of each connection, whether any signals are shorted the other signals, and to dynamically test (at operational speeds) the functionality of the bus and the entire interconnects system.

There is, therefore, a need for a method and circuitry to detect bus bit errors and to correct single bit failures without resorting to outside intervention such as service calls or machine stoppage.

### SUMMARY OF THE INVENTION

Communication buses between a driver chip and a receiving chip have a 2-way self-heal multiplexer (MUX) before each of the bit line drivers and after each of bit line receivers. The 2-way MUX on each data bit N couples the data for bit N to driver N or driver N+1 depending on the state of self-heal control signals from a driver self-heal control register. The 2-way MUX on each data bit N on the receiver directs a received bit N to either receive data path N or path N−1, in reverse order of the driver, depending on the state of self-heal control signals from a receiver self-heal control register. A driver self-test data shift register generates the self-test data for the drivers during test of the bus. The self-test driver shift register is serially loaded with a desired test pattern and the data is coupled in parallel to the line drivers. On the receiver side, a receiver expected data shift register is loaded with the same test pattern as “expected data.” The actual received data from the driver self-test data shift register is compared with the expected data in the receiver in receiver comparator circuitry on a per-bit basis. Each time there is a per-bit comparison failure, a logic one is stored in that bit location in the receiver bit error register. After test completion, the bit error register is loaded into the expected data shift register. The error data is shifted out of the expected data shift register and a total bit error counter is incremented by one each time a logic one is serially read-out of the receiver bit error register. The total bit error counter, after read-out of the receiver bit error register will contain a count K and K will be either zero, greater than one, or equal to one. If K is equal to one, then the bit path causing the failure is correctable give the capability to heal a single bit.

A error position counter is loaded with the total number of bits M in the data path. If K is equal to one, the receiver bit error register contains a logic one in the position corresponding to the failed bit path. When the error data in the expected data shift register is read-out, the error position counter is decremented by one and the value of the error position counter is latched into an error position register on each logic one read-out. At the end of the read-out, the error position register contains the position of the first error bit, and in the case K is equal to one, the location of the correctable single bit failure. To prepare to load the self-heal control registers, the value of the position latch is then loaded into the position counter and is used to shift a logic one into the error bit position in the expected data shift register on the receiver side and into the driver self-test shift register on the driver side.

The driver self-test shift register is then parallel loaded into the driver self-heal control register. The self-heal control register latches (driver and receiver) are daisy chained such that the logic one in failed bit N is shifted away (N to N+1, N+1 to N+2, etc.) towards the spare bit (M) which is at the end of the chain. If a logic zero selects the normal path for a data bit, then bit 0 through bit N−1 of the driver self-heal control register remain a logic zero, and bit (N+1) through bit M are set to a logic one. The data for bit N (failed bit) coupled through path N+1, N+1 through N+2, . . . and bit M−1 to spare bit M.

The data from the error position counter on the receiver side is used to shift a logic one into the receiver expected data shift register at the error bit position, and then expected data shift register is parallel loaded into the receiver self-heal control register. The receiver self-heal control register generates the receiver self-heal control signals that select the 2-way MUXes after the receivers in a reverse order (relative to the driver side) to re-align the data from the spare data path. Data from spare path M is shifted to path M−1, M−1 is shifted to M−2, . . . , until bit N+1 is shifted back to path N (failed path).

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of signal and clock distributions in clock groups according to embodiments of the present invention;

FIG. 2 is a circuit diagram of data and clock transmission paths suitable for practicing embodiments of the present invention;

FIG. 3 is a block diagram of circuitry used to test a communication bus between a driver and receiver chip;

FIG. 4 is a block diagram of circuitry used to select an alternate path for a failed bit in a communication bus between a driver and receiver chip;

FIG. 5 is a block diagram of circuitry used to correct a single bit failure according to embodiments of the present invention;

FIG. 6 is a data processing system suitable for practicing embodiments of the present system;

FIG. 7A is a flow diagram of method steps used in embodiments of the present invention to detect and correct a failed bit path;

FIG. 7B is a flow diagram of additional method steps used in embodiments of the present invention to detect and correct a failed bit path; and

FIG. 8 is a circuit block diagram of the self-heal control registers with a daisy chain connection according to embodiments of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits may be shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

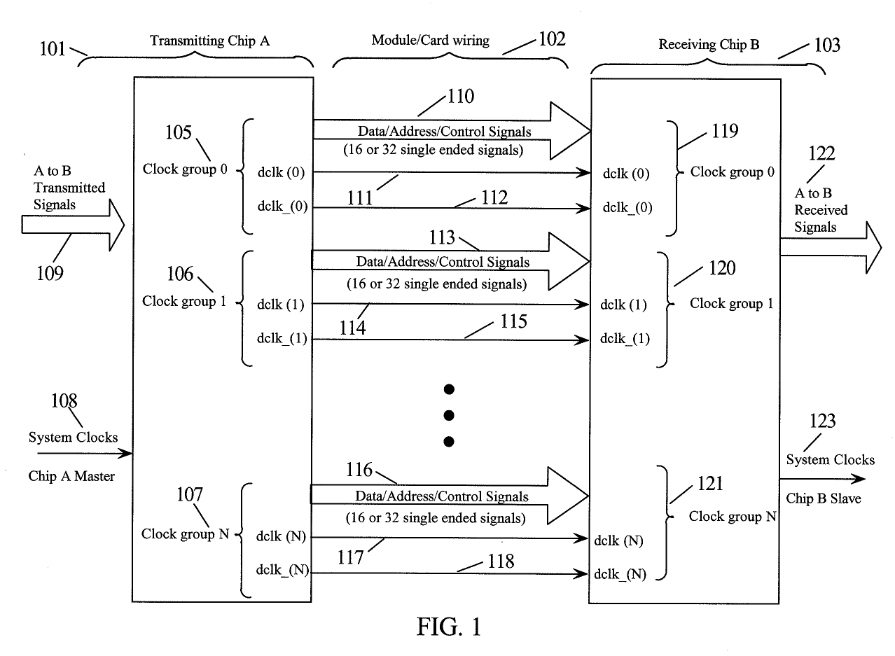

FIG. 1 is a block diagram of clock groups communicating between two chips where the signals may use pseudo-differential signaling. A transmitting integrated circuit (IC) chip A 101 receives signals 109 and system clocks 108 and transmits them over module/card wiring 102 to receiving IC chip B 103. Signals 109 are partitioned into “clock groups” in that a separate clock signal pair (clock signal and its complement) is sent with each signal group. Clock group 0 comprises Data/Address/Control Signals 110 and clock Dclk (0) 111 and Dclk_(0) 112. Clock group 1 comprises Data/Address/Control Signals 113 and clock Dclk (1) 114 and Dclk_(1) 115 and Clock group N comprises Data/Address/Control Signals 116 and clock Dclk (N) 117 and Dclk_(N) 118. The signals and clocks in these groups are received in receivers (not shown) as Clock group 0 119-Clock group (N) 121 are detected to generate received signals 122.

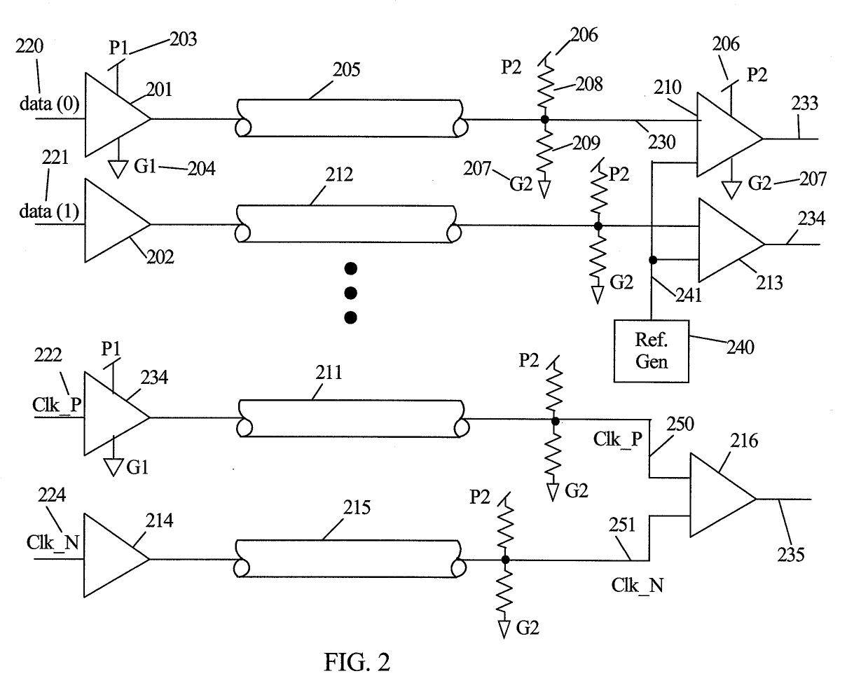

FIG. 2 is a circuit diagram of typical pseudo-differential signaling suitable for practicing embodiments of the present invention where data is transmitted from a driver to a receiver (e.g., within a clock group (0) 105 in FIG. 1). Exemplary reference generator (RG) 240 is used to generate a single reference (e.g., Vref 241) for multiple receivers (e.g., 210 and 213) within a clock group (e.g., within a clock group (0) 105 in FIG. 1). Drivers 201 and 202 represent two of a number of N drivers sending data to receivers 210 and 213, respectively. Exemplary driver 201 receives data 0 220 and generates an output that swings between power supply rail voltages P1 203 (logic one) and G1 204 (logic zero). When the output of driver 201 is at P1 203, any noise on the power bus is coupled to transmission line 205 along with the logic state of the data signal. Exemplary transmission line 205 is terminated with a voltage divider comprising resistors 208 and 209. Exemplary receiver input 230 has a DC bias value determined by the voltage division ratio of resistors 208 and 209 and the voltage between P2 206 and G2 207. Exemplary receiver 210 is powered by voltages P2 206 and G2 207 which may have different values from P1 203 and G1 204 due to distribution losses, noise coupling, and dynamic impedance of the distribution network. Exemplary receiver 210 is typically a voltage comparator or high gain amplifier that amplifies the difference between a signal at input 230 and a reference voltage 241. In this circuitry, driver side noise will not be reduced by common mode rejection as the reference voltage (e.g., Vref 241) does not contain driver side noise but rather reflects noise of the receiver side. A clock signal Clk_P 222 and its complement Clk_N 224 are coupled to transmission lines (TL) 211 and TL 215 with drivers 234 and 214, respectively. The clock signals Clk_P 222 and Clk_N 224 are received as Clk_P 250 and Clk_N 251 in a differential receiver 216 that may employ duty cycle compensation circuitry according to embodiments of the present invention. Differential receiver circuitry 216 generates a single ended signal at output 235 which may then be buffered for distribution within an IC.

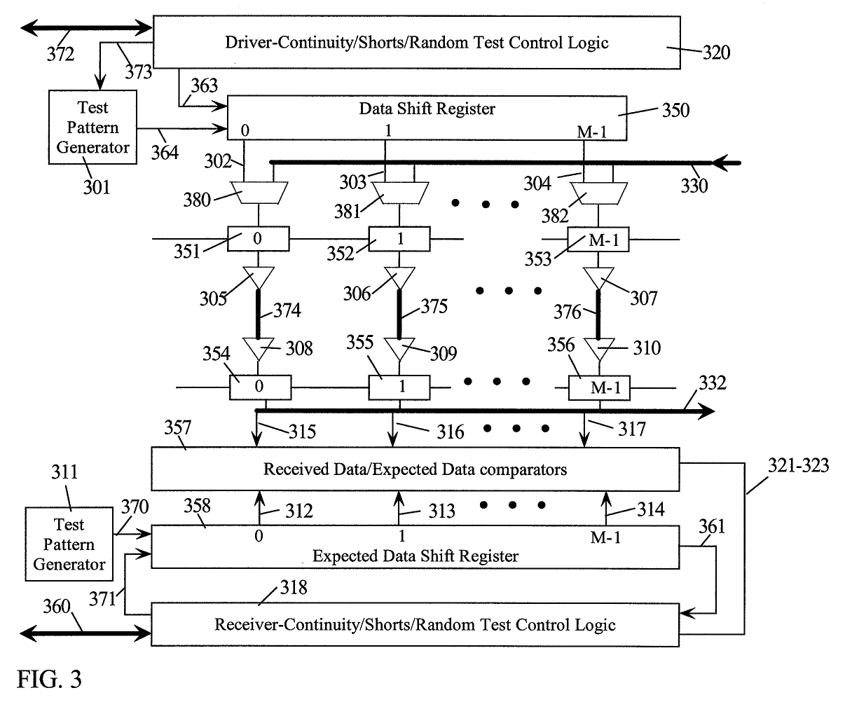

The following describes operations that have been implemented in the past for detecting and correcting bus data bit failures within a clock group (e.g., clock group 119-121 in FIG. 1). FIG. 3 is a block diagram of circuitry used for these operations.

On the driver side, test control logic 320 controls the loading of a test pattern 364 which is shifted into data shift register 350 having parallel outputs 302-304 each associated with a data bit. Multiplexers (MUXes) 380-382 select between functional data bits 330 and the test data on outputs 302-304. Scan chain registers 351-353 may be used to scan in and scan out data. After loading shift register 350, the drivers 305-307 send the parallel test data over the interface bus lines 374-376 to receivers 308-310. Again, scan chain registers 354-356 may be used to scan in and scan out data. Received functional data bits 332 are directed to functional logic and test data bits 315-317 are coupled to comparator circuitry 357 that compares the actual received test data with the expected test data bits 312-314.

The expected test data bits are generated in test pattern generator 311 and serially shifted on line 370 in response to shift signal 371 from receiver test logic 318. The start of the receive data is detected in logic 318 and shifting of an identical test pattern 311 is started into “expected data” shift registers 358. The received data 315-317 is then compared in compare circuitry 357 with the data in the “expected data” shift register latches 312-314. A miss-compare occurence (indicated by fail signals 321-323) indicates a faulty connection or impaired signaling. For every bus bit miss-compare, a per-bit error latch (in logic 318) is set. System level controls are coupled to driver test logic 320 with signals 372 and receiver test logic 318 with signals 360.

At the conclusion of the tests, the data clocks are stopped and the receiver error registers are scanned out of logic 318 using a standard system latch scanning/testing mechanism (e.g., LSSD scanning). Using system bring-up software and associated look-up table, a correlation is made between the error latches and associated signal lines and any available corrective action is initiated.

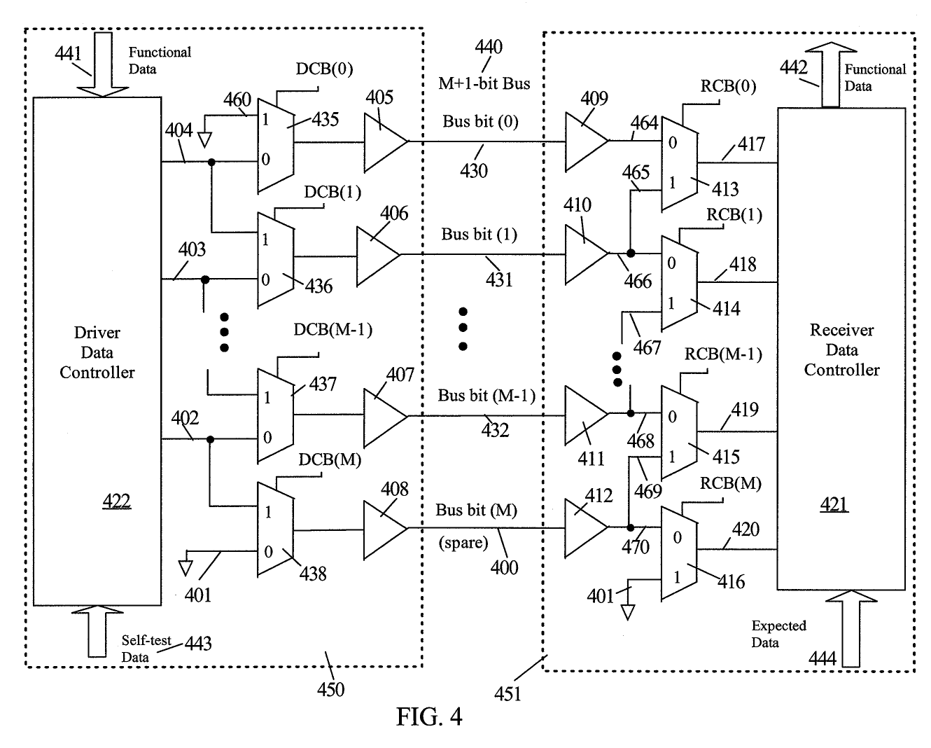

FIG. 4 is a block diagram that shows a self-repair (heal) mechanism. A spare bit (path) 400 is implemented for each bus or for a group of bits on the bus 440 (e.g., clock groups 119-121 in FIG. 1) on both driver chip 450 and receiver chip 451. Spare bit 400 receives data (e.g., 401 or 402), has driver 408, is wired to a receiver 412, and is de-skewed (elastic receiver bit) 420 on system bring-up as with the other normal data bits (e.g., 430-432) on the bus 440. Shorts and continuity testing as well as random data self-test operations are performed on the bus 440 (e.g., using logic 318 in FIG. 3). If any self-test failures (e.g., fails 321-323 in FIG. 3) are detected, the system clocks (not shown) are stopped and the per-bit error latches (not shown in logic 318 in FIG. 3) in the receiver chip 451 are scanned out and analyzed by the system bring-up control processors (not shown) and procedures. If the system bring-up processors and procedures determine that a self-test failure can be repaired via the self-heal mechanism, proper self-healing control latches are set by scan-loading these values into both the receiver chip 451 and the driver chip 450. If a bit N is determined to be the failed bit, then by setting a self-heal control latch for bit N on the driver, self-heal control latches for the subsequent latches in a self-heal order, N+1, and N+2, etc., to the last (spare) bit (e.g., spare bit (M) 400 on the bus 440 are set via simple logic built into hardware 421 and 422 on the chips 450 and 451, respectively. This procedure will route functional data bit N, originally driven on signal line N, onto signal line N+1, while functional data bit (N+1) is driven to line N+2, and so forth until the last functional data bit M−1 is driven onto the last or spare bit M. This process shifts any functional data which is being driven (drivers 405-407) onto a faulty signal line to its physically adjacent neighboring signal line via a simple 2-way multiplexer (MUX) structure 435-437 with subsequent data bit similarly “shifted” until the last functional data bit is shifted to a spare signal line 400. By setting the self-heal control latch for bit N on the receiver chip 451, self-heal control latches for the subsequent latches in the self-heal order are also set as described above relative to the driver chip 450.

After the failed bit on the bus has been “healed” or corrected, the received data may be put back in the proper order using a MUX structure in receiver chip 451. Working in the opposite direction, the N+1 signal wire, which has received (receivers 409-412) the driven functional data bit N, is shifted via a 2-way MUX (e.g., 413-416) back to bit N. Subsequent shifting occurs on the preceding N+2, N+1, etc. paths until the spare signal bit M, which carries the last functional data bit M−1, is shifted back to the receiver bit M−1. When the previous reconfiguration is so implemented, the failed bit N is no longer used for sending functional data and the spare bit M is used instead. Driver data controller 422 and receiver data controller 421 are used to perform necessary operations to direct the shifting operations.

The prior art methods for collecting, analyzing, and reconfiguring bus errors create problems in order to use the built-in self-healing mechanism. These prior art methods required the following processes:

1. Running the test and getting a summary pass/fail result via normal system bring-up processor communication operations.

2. If a failure is reported, stopping the functional clocks for both driver and receiver chips in the interface.

3. Using chip diagnostics and testing scan methods (LSSD scan paths) to scan out the failure indicating registers on the receiving chip.

4. Extensive look-up tables to identify the self-test per-bit error indicator latches from other scan-out latches.

5. Analysis of these latches to determine that there is only one bit failure associated with each self-heal clock group (e.g., clock group 119-121 in FIG. 1) of bits that have an associated spare data bit used for self-healing.

6. More use of look-up tables to identify the corresponding self-heal control register bit for both driver and receiver.

7. Scanning in the setting for self-heal control registers on the driver chip.

8. Scanning in the settings for the self-heal control registers on the receiving chip.

9. Starting functional clocks for the driver and the receiver chip and resume system bring-up.

These procedures require considerable overhead and are complicated.

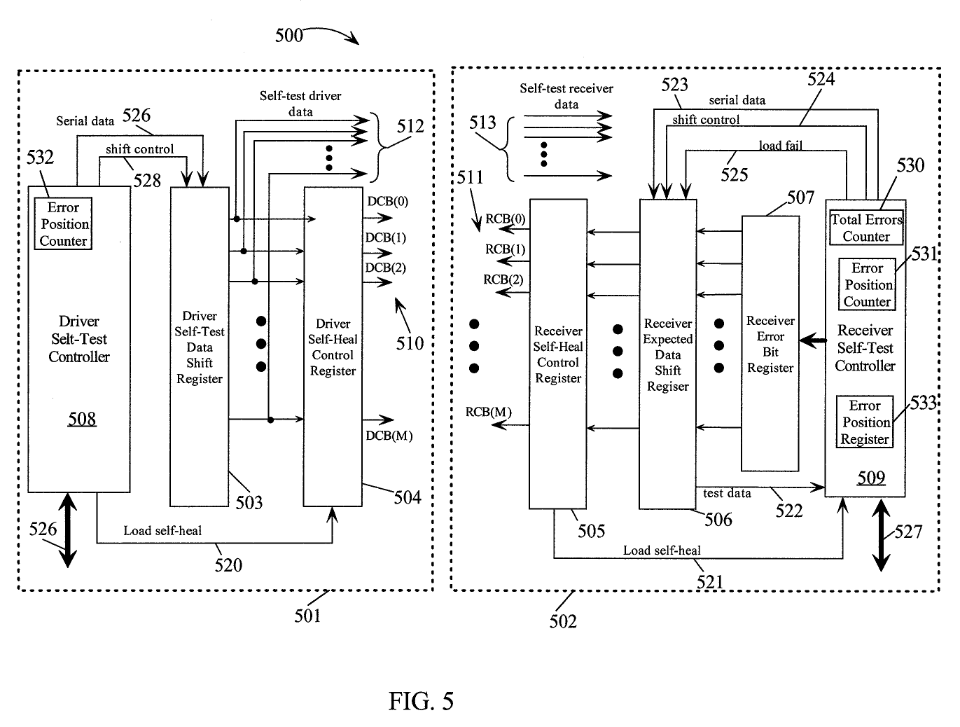

FIG. 5 is a block diagram of a bus bit automatic error detection and correction system 500 according to embodiments of the present invention. In system 500, the process for testing the bus by shifting test patterns, driving them onto a bus, receiving and comparing the data results as discussed relative to FIG. 3 and FIG. 4. However, the procedures 1-9 outlined above do change. The present invention simplifies these processes by moving many of the analysis and table-based steps into relatively straightforward, hardware based mechanisms in the driver and receiver chips (e.g., 450 and 451).

FIG. 5 illustrates self-test and self-heal registers on the driver chip 501 and receiver chip 502 without the details of the data paths which have been described relative to the prior art. The present invention has the following hardware differences from the prior art. In driver chip 501, the driver self-test shift register 503 and driver self-heal control register 504 are implemented as before. However, a means is provided for parallel loading the driver self-heal register 504 from the contents of the driver self-test shift register 503 using a driver load self-heal signal 520. Similarly, on the receiver side, the receiver expected data shift register 506, per-bit receiver self-test error register 507, and receiver self-heal control register 505 are implemented as before. However, as on the driver side, a means is provided for parallel loading the receiver self-heal control register 505 from the receiver expected data shift register 506 using a receiver load self-heal signal 521. Also implemented is a means for parallel loading contents of the receiver error bit register 507 into the receiver expected data shift register 506. Also implemented, in the receiver self-test controller 509, are two counters; a self-test error position counter 530 and a total errors counter 531 along with an error position register 533. Similarly, in the driver self-test controller 508, a self-test error position counter 532 is implemented.

Driver control bits DCB(0)-DCB (M) (signals 510) are used to control the driver self-heal MUXes (e.g. 435-438 in FIG. 4). Likewise, receiver control bits RCB(0)-RCB (M) (signals 511) are used to control the receiver self-heal MUXes (e.g., 413-416 in FIG. 4). Self-test driver data 512, from driver self-test controller 508, are coupled to the drivers (e.g., 305-307 in FIG. 3) and self-test receiver data 513 coupled to comparator (e.g., 357 in FIG. 3) that compares received data to expected data during test.

The following is the process by which the previously enumerated steps for testing and self-heal reconfiguration, explained relative to FIG. 3 and FIG. 4, are implemented using the added hardware in FIG. 5 according to embodiments of the present invention. The self-test operation between the driver chip 501 and receiver chip 502 is executed as previously described.

If a summary self-test error bit (e.g., fail 321-323) is set at the end of a self-test indicating a test failure, the per-bit errors from per-bit receiver error bit register 507 are parallel loaded into the receiver expected data shift register 506 using the receiver load load-fail signal 525. The receiver's self-test controller 509 then shifts these error bits out of the expected-data shift register 506 as test data 522 while counting the number of bits that are set to logic one using the total errors counter 530. Each shift also decrements the self-test error position counter from a preset value M corresponding to the number of bits in the receiver expected data shift register 506. Whenever a logic one error bit is shifted out, the present value of the self-test error position counter (not shown) is loaded into the error position holding register (not shown). When the self-test error position counter has decrement to 0, the shifting has completed and the total errors counter indicates how many bits are in error while the error position register 533 contains the position in the self-test shift order of the first failed bit in the self-test order.

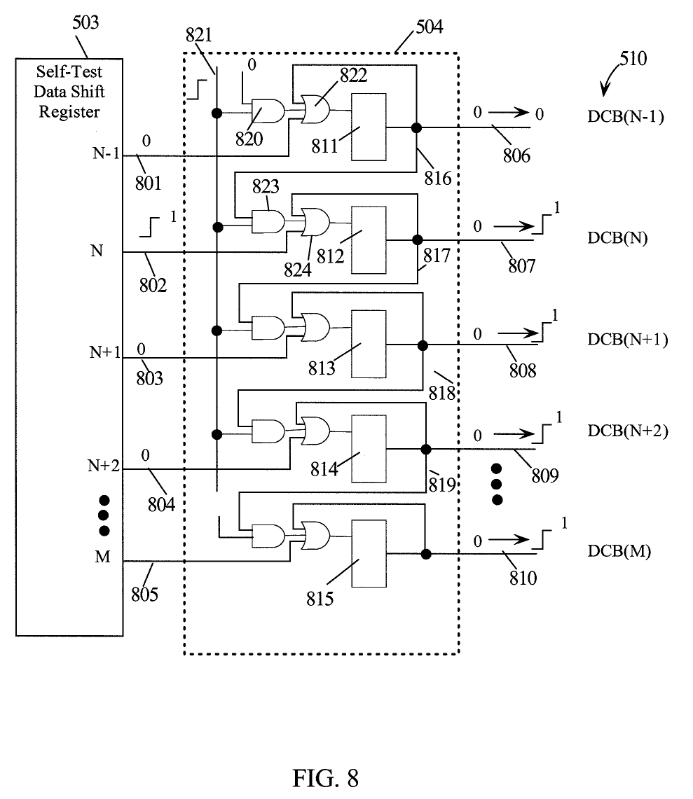

System software can then read the receiver self-test status registers, determine if a failure has occurred, and read the total errors counter (530 and 532) and error position register 533. If there were no errors, then the interface is ready to continue normal bring-up procedures. If there is more than one error in the total error counter, then there are more failed bus bits than can be self-healed and a bus failure error is posted. If the total error count register indicates only one failed bit, then the error position register will indicate which bit has failed in the self-test order. The receiver self-test error position register 533 can then the value in the error position register 533 can be loaded into the driver's (driver chip 501) self-test error position counter 531 and used to count the shifting of a single “logic one” bit into the self-test shift register 503 at the position corresponding to the bit which failed self-test. The driver self-test shift register 503 contents are then parallel loaded into the driver self-heal control register 504, which sets the self-heal bit corresponding to the failed bit. The self-heal control bits are set up in a daisy chain connection such that when bit N is set to a logic one in the chain, the subsequent bits N+1, and N+2, etc., to the end of the chain are also set to a logic one (See FIG. 8). Thus, similarly setting all the self-heal control latches causes the functional data (e.g., functional transmit data 330 in FIG. 3) to be shifted towards the spare signal and away from the failed signal. Similarly, in receiver chip 502, a logic one is shifted into the error position in the receiver expected data shift register 506 and then self-heal control register 505 is parallel loaded. Now for the M bit bus, the self-heal control signals for the receiver chip 501 and the driver 502 have logic states (e.g., logic zero) that select, with 2-way MUXes, the normal path for all bits below failed bit N (e.g., N−1, N−2, . . . 0) and logic one states for all bits N+1, N+2, . . . M that select, with 2-way MUXes, the shifted path for all bits above bit N to the spare bit M.

Using the steps above, the bus interface paths (e.g., 374-376) may be self-tested and a single signal error self-healed with the following advantages:

Only simple system controller (e.g., 508 and 509) commands are needed to test and heal a bus. System functional clocks do not need to be stopped and no LSSD style scanning of registers is needed to get error latch information or to set self-heal latches. No tables of error latch position and self-heal latch position are needed.

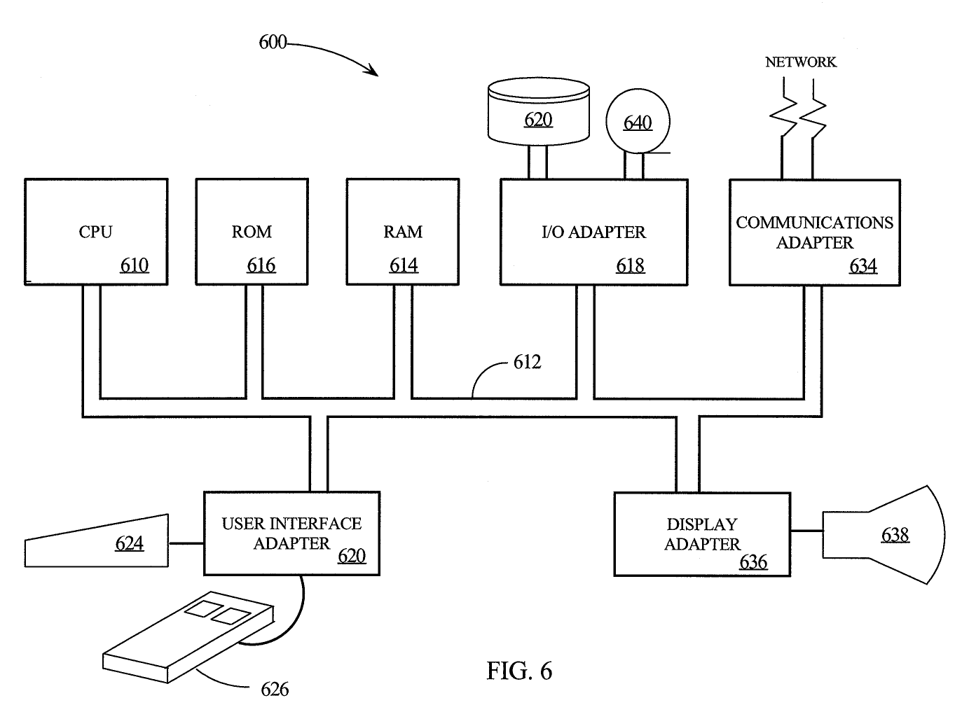

FIG. 6 is a high level functional block diagram of a representative data processing system 600 suitable for practicing the principles of the present invention. Data processing system 600 includes a central processing system (CPU) 610 operating in conjunction with a system bus 612. System bus 612 operates in accordance with a standard bus protocol, such as the ISA protocol, compatible with CPU 610. CPU 610 operates in conjunction with electronically erasable programmable read-only memory (EEPROM) 616 and random access memory (RAM) 614. Among other things, EEPROM 616 supports storage of the Basic Input Output System (BIOS) data and recovery code. RAM 614 includes, DRAM (Dynamic Random Access Memory) system memory and SRAM (Static Random Access Memory) external cache. I/O Adapter 618 allows for an interconnection between the devices on system bus 612 and external peripherals, such as mass storage devices (e.g., a hard drive, floppy drive or CD/ROM drive), or a printer 640. A peripheral device 620 is, for example, coupled to a peripheral control interface (PCI) bus, and I/O adapter 618, therefore, may be a PCI bus bridge. User interface adapter 622 couples various user input devices, such as a keyboard 624 or mouse 626 to the processing devices on bus 612. Display 638 which may be, for example, a cathode ray tube (CRT), liquid crystal display (LCD) or similar conventional display units. Display adapter 636 may include, among other things, a conventional display controller and frame buffer memory. Data processing system 600 may be selectively coupled to a computer or telecommunications network 641 through communications adapter 634. Communications adapter 634 may include, for example, a modem for connection to a telecom network and/or hardware and software for connecting to a computer network such as a local area network (LAN) or a wide area network (WAN). CPU 610 and other components of data processing system 600 may contain logic circuitry in two or more integrated circuit chips that are separated by a significant distance relative to their communication frequency such that pseudo-differential signaling employing embodiments of the present invention is used to detect and correct bit errors on a bus connecting the two or more integrated chips according to embodiments of the present invention.

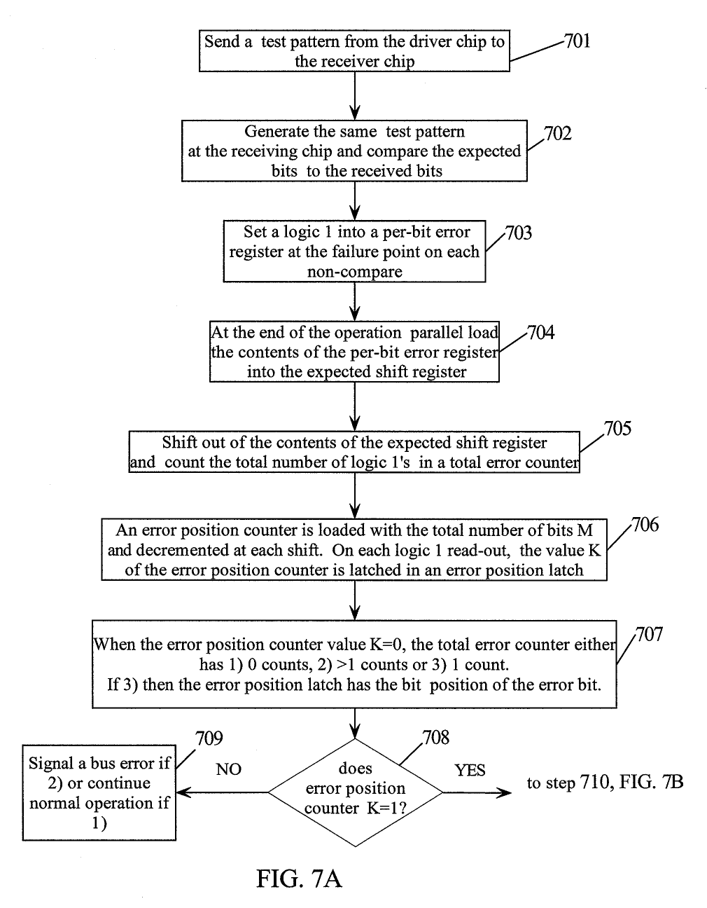

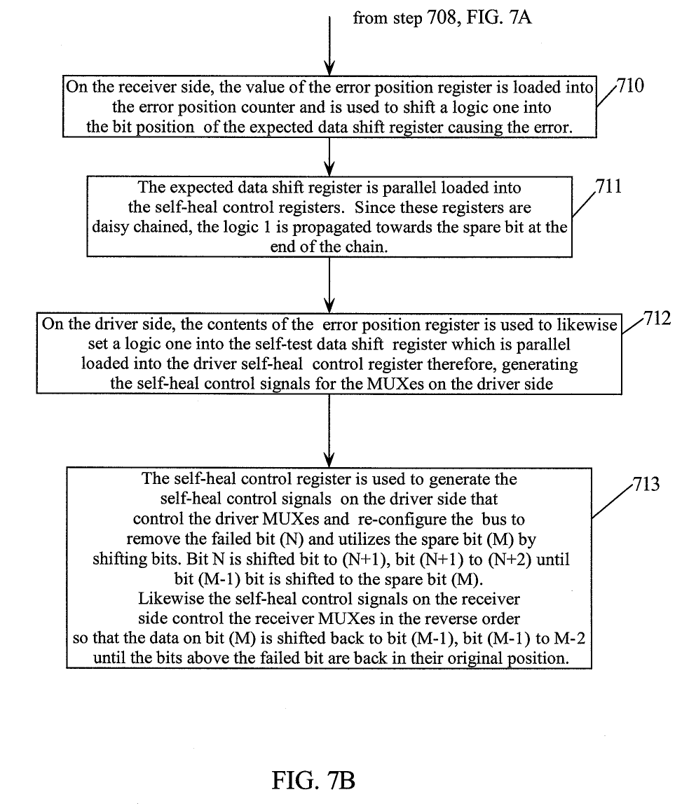

FIGS. 7A and 7B are flow diagrams of method steps used in embodiments of the present invention. In step 701, a test pattern is sent from the driver chip to the receiver chip. In step 702, the same test pattern is generated at the receiver chip generating expected test data bits that are compared to the received test bit. In step 703, a logic one is set to an error bit register position corresponding to a failed bit on each non-compare. In step 704, the contents of the error bit register are parallel loaded into an expected data shift register. In step 705, the contents of the expected data shift register are shifted out and a total error counter is used to count the total number of logic ones. Likewise, in step 706, a error position counter is loaded with the total number of bus bits (e.g., M) and decremented on each shift of the expected data shift register. On each logic read out, the value of the error position counter (e.g., 531) is latched into an error position register. In step 707 a determination is made whether the value K of the total error counter is equal to zero, greater than one, or equal to one. In step 708 a test is done to determine if the value of the total error counter is equal to one. If the result of the test in step 708 is NO, then in step 709, normal procedures are continued if the value is zero and a bus error is signaled if the value is greater than one.

If the result of the test in step 708 is YES, then a branch is taken to step 710 in FIG. 7B where the value of the error position register is loaded into the error position counter and is used to shift a logic one into the expected data shift register at the bit position of the expected data shift register corresponding to the failed bit. In step 711, the expected data shift register is then parallel loaded into the self-heal control register. Since the self-heal control register is daisy chained, the logic one propagates toward the spare bit at the end of the chain. In step 712, the error position register from the receiver is used to likewise set the logic one in the self-test data shift register (in the driver chip) which is then parallel loaded into the driver self-heal control register. This action, in turn, generates the self-heal control signals for the driver side as in the receiver chip that control the MUXes which shift the received data into the correct data path.

In step 713, the self-heal control register generates the self-heal control signals that control the MUXes (in both the drive and the receiver chip) which reconfigure the bus to remove the failed bit path N and substitute spare bit M. In the driver, the failed bit N is shifted to N+1, (N+1) to N+2, etc; until bit M−1 is shifted to the spare bit M. In this manner, the failed data path (e.g., N) is removed and the spare data path (M) is substituted. On the receiver side, the receiver MUXes are configured to reverse the order of the driver side such that the data receiver on the spare bit M is shifted back to bit M−1, bit M−1 is shifted to bit M−2 and so forth such that the received bits are put back in their original position.

FIG. 8 is a circuit block diagram illustrating details of driver self-heal control register 504 according to embodiments of the present invention. Driver self-test data shift register 503 is shown with a subset of its outputs N−1 801-M 805. A failed data bit is indicated at output N 802 by the fact that the logic state of N 802 transitions to a logic one when a logic one (indicating one error) is shifted in by driver self-test controller 508. All other states are a logic zero. The exemplary circuit comprising AND gate 819, OR gate 820 and latch 811 are explained to illustrate what happens at each bit position (e.g., shown outputs N−1 801-M 805). A parallel load signal 821 is used to enable all of the AND gates (e.g., 819). AND gate 819 receives the output of the preceding latch (not shown) for bit position (N−2). Since it precedes the failed bit, its output is a logic zero. Therefore, a logic zero is loaded into latch 811 and AND gate 822 is disabled. However, the logic one at N 802 sets a logic one to latch 812 (due to the OR gate 823) and DCB(N) 807 transitions to a logic one. Daisy chain connections (815-818) cause the logic one to propagate such that driver control bits DCB(N) through DCB(M) are set to a logic one (all bits after the failed bit). All the bits before the failed bit have control bits DCB(0)-DCB(N−1) equal to zero. In this manner, the daisy chained self-heal control register provides the correct control signals for the MUXes (e.g., 435-438 and in FIG. 4) such that a failed bit N is removed and the spare bit M is substituted by shifting data from bit N to bit (N+1) bit (N+1) to bit (N+2), until bit (M−1) is shifted to spare bit (M). The receive side MUXes (e.g., 413-416) are configured to select in the reverse order such that the received data bits are put back in their correct order before the spare data path was substituted for the failed data path.

Although the present invention and its advantages have been described in detail, it should be understood that various changes, substitutions and alterations can be made herein without departing from the spirit and scope of the invention as defined by the appended claims.

1. A system for substituting a spare bit data path for a failed bit data path in a number M+1-bit communication bus having M normal data path positions (0 to M−1) and a spare data path position M, comprising:
a driver selection circuit that outputs a number M+1 driver input signals by selecting (in data path positions 1 to M−1) from a number M−1 normal data input signals and the number M−1 alternate data input signals in response to M−1 driver control signals, and by selecting in data path position 0 a normal data input signal 0 as driver input signal for position 0 and by selecting in data path position M an alternate data input signal M as driver input signal for position M, wherein a normal data input signal in position K of the M−1 normal data input signals is selected as a driver input signal for position K (in data paths 1 to M−1) when driver control signal for position K is a logic zero and an alternate data input signal for position K of the M−1 alternate data input signals is selected as the driver input signal for position K when the driver control signal for position K is a logic one; and
a driver control register for generating the M−1 driver control signals in response to a parallel load of an error bit into an error bit position N of the driver control register, wherein a logic one loaded into the error bit position N of the driver control register is propagated to each bit position after N while each bit position before error bit position N remains at a logic zero state.

2. The system of claim 1 further comprising:
a receiver selection circuit that outputs a number M receiver data output signals by selecting (in data path positions 0 to M−1) from a number M normal receiver output signals and the number M alternate receiver output signals in response to M receiver control signals, wherein a normal receiver output signal in position K of the M normal receiver output signals is selected as a receiver data output for position K (in data paths 0 to M−1) when receiver control signal in position K is a logic zero and an alternate receiver data output signal K of the M alternate receiver output signals is selected as the receiver data output signal for position K when the receiver control signal in position K is a logic one; and
a receiver control register for generating the M driver control signals in response to a parallel load of an error bit into an error bit position N of the receiver control register, wherein a logic one loaded into the error bit position N of the receiver control register is propagated to each bit position after N while each bit position before error bit position N remains at a logic zero state.

3. The system of claim 1, wherein the alternate data input signal K is a normal data input signal K−1.

4. The system of claim 2, wherein the alternate receiver output signal K is a normal receiver output signal K+1.

5. The system of claim 4 further comprising:
an M-bit driver self-test data shift register, coupled to the driver control register, receiving first serial data and generating the error bit at error bit position N; and
an M-bit receiver expected data shift register, coupled to the receiver control register, receiving the first serial data and generating the error bit at error bit position N for the receiver control register.

6. The system of claim 5, wherein the M-bit expected data shift register is coupled to an M-bit error register having a first logic state set to each bit P position where a sent test bit P fails to compare to an expected bit P.

7. The system of claim 6, wherein the contents of the M-bit error register are loaded into the M-bit expected data shift register and shifted out as test data.

8. The system of claim 7 further comprising a total error counter and an error position counter, wherein the total error counter counts logic one states in the test data when the test data is shifted out of the M-bit expected data shift register.

9. The system of claim 8 further comprising an error position register, wherein the error position counter is preset to a count of M and decremented by one for each bit of the test data shifted out of the M-bit expected data shift register and the contents of the error position counter are loaded into the error position register each time a bit of the test data reads out as a logic one state.

10. The system of claim 8, wherein the contents of the M-bit expected data shift register are parallel loaded setting the error bit at error bit position N for the receiver control register in response to a receiver load self-heal control signal.

11. The system of claim 8, wherein the contents of the error position register are loaded to a driver error position counter in a driver self-test controller and the driver self-test controller decrements the driver error position counter while shifting a logic one into the M-bit driver self-test data shift register until the driver error position counter decrements to a count of zero.

12. The system of claim 11, wherein the contents of the M-bit driver self-test data shift register are parallel loaded setting the error bit at error bit position N for the driver control register in response to a driver load self-heal control signal.

13. The system of claim 1, wherein the driver selection circuit comprises a number (M−1) 2-way MUXes, each of the (M−1) 2-way MUXes receiving one of the (M−1) normal data input signals, one of the M alternate data input signals, and a corresponding one of the M−1 driver control signals, and outputting one of the (M−1) driver input signals for data paths (1 to M−1).

14. The system of claim 2, wherein the receiver selection circuit comprises a number (M) 2-way MUXes, each of the (M) 2-way MUXes receiving one of the M normal receiver output signals, one of the M alternate receiver output signals, and a corresponding one of the M receiver control signals, and outputting one of the M receiver output signals for data paths 0 to M.

15. (canceled)

16. A data processing system comprising:
a processor central processing unit (CPU);
a random access memory (RAM);
a read only memory (ROM); and
one or more communication buses in the data processing system having circuitry for substituting a spare bit data path for a failed bit data path in a number M+1-bit communication bus having M normal data paths (0 to M−1) and a spare data path M, a driver selection circuit that outputs a number M+1 driver input signals by selecting (in data path positions 1 to M−1) from a number M−1 normal data input signals and the number M−1 alternate data input signals in response to M−1 driver control signals, and by selecting in data path position 0 a normal data input signal 0 as driver input signal for position 0 and by selecting in data path position M an alternate data input signal M as driver input signal for position M, wherein a normal data input signal in position K of the M−1 normal data input signals is selected as a driver input signal for position K (in data paths 1 to M−1) when driver control signal for position K is a logic zero and an alternate data input signal for position K of the M−1 alternate data input signals is selected as the driver input signal for position K when the driver control signal for position K is a logic one

17. The data processing system of claim 16 further comprising:
a receiver selection circuit that outputs a number M receiver data output signals by selecting (in data paths 0 to M−1) from a number M normal receiver output signals and the number M alternate receiver output signals in response to M receiver control signals, wherein a normal receiver output signal in position K of the M normal receiver output signals is selected as a receiver data output for position K (in data paths 0 to M−1) when receiver control signal in position K is a logic zero and an alternate receiver data output signal K of the M alternate receiver output signals is selected as the receiver data output signal for position K when the receiver control signal in position K is a logic one; and
a receiver control register for generating the M driver control signals in response to a parallel load of an error bit into an error bit position N of the receiver control register, wherein a logic one loaded into the error bit position N of the receiver control register is propagated to each bit position after N while each bit position before error bit position N remains at a logic zero state.

18. The data processing system of claim 17, wherein the alternate data input signal for position K is a normal data input signal for position K−1.

19. The data processing system of claim 18, wherein the alternate receiver output signal for position K is a normal receiver output signal for position K+1.

20. The data processing system of claim 19 further comprising:
an M-bit driver self-test data shift register, coupled to the driver control register, receiving first serial data and generating the error bit at error bit position N; and
an M-bit receiver expected data shift register, coupled to the receiver control register, receiving the first serial data and generating the error bit at error bit position N for the receiver control register.
